(19) United States
(12) Patent Application Publication
(10) Pub. No.: US 2017/0156038 A1
(43) Pub. Date: Jun. 1, 2017

(54) DEVICE GROUP MANAGEMENT SYSTEM, METHOD AND APPARATUS

(71) Applicant: Xiaomi Inc., Beijing (CN)

(72) Inventors: Hong CHEN, Beijing (CN); Weiguang JIA, Beijing (CN); Enxing HOU, Beijing (CN)

(73) Assignee: Xiaomi Inc., Beijing (CN)

(21) Appl. No.: 15/360,492

(22) Filed: Nov. 23, 2016

(30) Foreign Application Priority Data
Nov. 27, 2015 (CN) 201510847066.9

(51) Int. Cl. H04W 4/08; H04W 24/02; H04L 29/08

(52) U.S. Cl. CPC H04W 4/08; H04L 67/1044; H04W 24/02

(57) ABSTRACT

A device group management system, method, and apparatus are provided. The method includes: after receiving an adding instruction of adding a target device into a target group, sending a broadcasting instruction to the target device where the broadcasting instruction triggers the target device to broadcast a signal, receiving signal strengths sent by reference devices where at least one of the signal strengths is signal strength of a received broadcasted signal which is acquired by one of the reference devices after it receives the broadcasted signal, and sorting the reference devices based on the signal strengths fed back by the reference devices.

### CROSS-REFERENCE TO RELATED APPLICATION

This application is based on and claims priority of the Chinese Patent Application No. 201510847066.9, filed on Nov. 27, 2015, which is incorporated herein by reference in its entirety.

### TECHNICAL FIELD

The present disclosure is related to the field of smart home, and more particularly, to a device group management system, method and apparatus for the smart home.

### BACKGROUND

As the number of smart devices in a home increases, a user may want to group multiple smart devices. In the existing grouping process, the user may have to sequentially find the smart devices and add the found smart devices into a group. The process of identifying a number of smart devices one by one may not be efficient and errors may occur. As such, an efficient grouping method, system and apparatus are needed to group the smart devices in a home without identifying the smart devices one by one sequentially. However, technical challenges exist for finding and grouping smart devices in the home.

### SUMMARY

According to a first aspect of the examples of the present disclosure, a device group management system is provided. The device group management system may include a management terminal, a target device and reference devices. The management terminal is configured to, after receiving an adding instruction for adding the target device into a target group, send a broadcasting instruction to the target device. The target device is configured to, after receiving the broadcasting instruction, broadcast a signal. Each of the reference devices is configured to, after receiving the signal, acquire signal strength of the received signal and feed the signal strength back to the management terminal. The management terminal is further configured to sort the reference devices based on the signal strength of each reference device fed back by the reference devices.

According to a second aspect of the examples of the present disclosure, a device group management method is provided. The method may include: after receiving an adding instruction for adding a target device into a target group, sending a broadcasting instruction to the target device where the broadcasting instruction triggers the target device to broadcast a signal, receiving signal strengths sent by reference devices where each of the signal strengths is signal strength of a received signal broadcasted by the target device and is acquired by one of the reference devices after it receives the broadcasted signal, and sorting the reference devices based on the signal strengths fed back by the reference devices.

According to a third aspect of the examples of the present disclosure, a device group management apparatus is provided, the apparatus may include: a sending module configured to, after an adding instruction for adding a target device into a target group is received, send a broadcasting instruction to the target device where the broadcasting instruction triggers the target device to broadcast a signal, a signal strength receiving module configured to receive signal strengths sent by reference devices where each of the signal strengths is signal strength of a received signal broadcasted by the target device and is acquired by one of the reference devices after it receives the signal, and a sorting module configured to sort the reference devices based on the signal strengths fed back by the reference devices and received by the signal strength receiving module.

According to a fourth aspect of the examples of the present disclosure, a device group management apparatus is provided. The apparatus may include: a processor and a memory storing instructions executable by the processor. The processor is configured to: after receiving an adding instruction for adding a target device into a target group, send a broadcasting instruction to the target device where the broadcasting instruction is configured to trigger the target device to broadcast a signal, receive signal strengths sent by reference devices where each of the signal strengths is signal strength of a received signal broadcasted by the target device and is acquired by one of the reference devices after it receives the signal, and sort the reference devices based on the signal strengths fed back by the reference devices.

It should be understood that both the foregoing general description and the following detailed description are exemplary and explanatory only and are not restrictive of the disclosure.

### BRIEF DESCRIPTION OF THE DRAWINGS

The disclosed examples will be better understood and features, aspects and advantages other than those set forth above will become apparent when consideration is given to the following detailed description thereof. Such detailed description makes reference to the following drawings.

FIG. 1 is a schematic diagram showing an application environment where a device group management method is implemented;

FIG. 2A is a block diagram showing a device group management system according to an example;

FIG. 2B is a schematic diagram showing an example interface for device group management displayed in a mobile terminal;

FIG. 3 is a flow chart showing a device group management method according to an example;

FIG. 4A is a flow chart showing a device group management method according to another example;

FIG. 4B is a flow chart showing a device group management method according to yet another example;

FIG. 4C is a flow chart showing a device group management method according to an additional example;

FIG. 5 is a block diagram showing a device group management apparatus; and

FIG. 6 is an example system diagram showing a device group management apparatus.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present invention. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to exemplary examples, examples of which are illustrated in the accompanying drawings. The following description refers to the accompanying drawings in which the same numbers in different drawings represent the same or similar elements unless otherwise presented. The examples set forth in the following description of exemplary examples do not represent all examples consistent with the disclosure. Instead, they are merely examples of apparatuses and methods consistent with aspects related to the disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one example,” “an example,” “exemplary example,” or the like in the singular or plural means that one or more particular features, structures, or characteristics described in connection with an example is included in at least one example of the present disclosure. Thus, the appearances of the phrases “in one example” or “in an example,” “in an exemplary example,” or the like in the singular or plural in various places throughout this specification are not necessarily all referring to the same example. Furthermore, the particular features, structures, or characteristics in one or more examples may be combined in any suitable manner.

A smart device is an electronic device, generally connected to other devices or networks via different wireless protocols that can operate to some extent interactively and autonomously. Several notable types of smart devices are smart phones, phablets and tablets, smart watches, smart bands and smart key chains. Some traditional home devices such as lamp may become the smart device when traditional home devices are enhanced by adding additional network hardware so that the home devices may connect to the network. A home becomes a smart home when some or all home devices are smart devices.

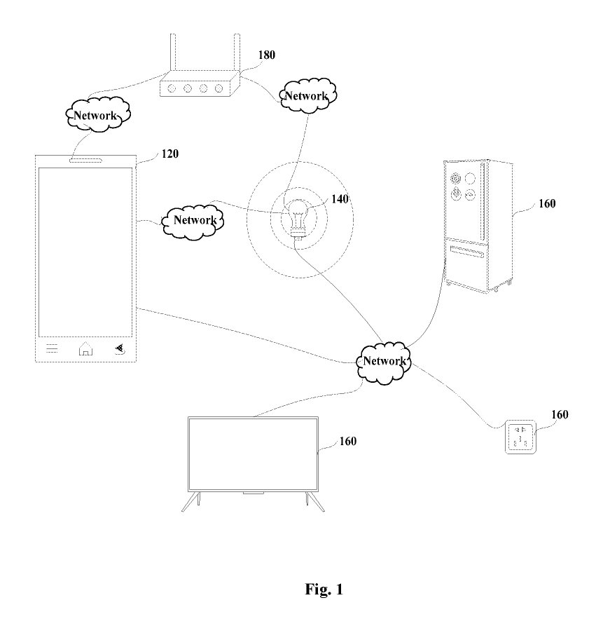

FIG. 1 is a schematic drawing showing an application environment where a device group management method is implemented. As shown in FIG. 1, the application environment may include a management terminal 120, a target device 140 and reference devices 160.

The management terminal 120 may be a mobile phone, a tablet computer, a server or the like.

The target device 140 and the reference devices 160 the may be devices having a radio signal transceiving function, such as smart electric lamps, smart sockets, smart TVs, smart air conditioners, smart refrigerators or the like. In the present disclosure, a selected smart device to be added into a target group is taken as the target device 140, the remaining smart devices are taken as the reference devices 160.

In actual home, the target device 140 and some reference devices 160 may be located in the same room, while other reference devices 160 may be located in different rooms.

The management terminal 120 and the target device 140 may be connected to each other via wired or wireless networks.

Optionally, the application environment may include a router 180 which provides Wireless-Fidelity (Wi-Fi) connections for the management terminal 120, the target device 140 and the reference devices 160.

All the following example will be described in the way that they may be implemented in the application environment shown in FIG. 1.

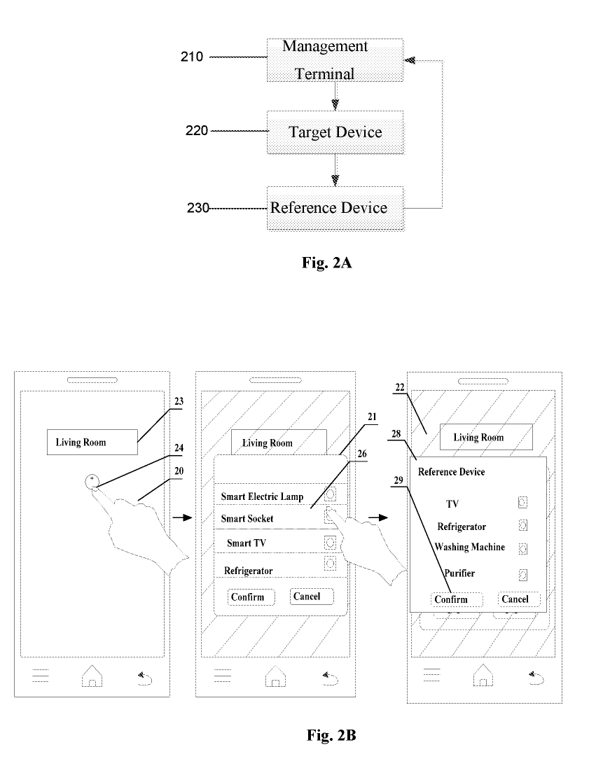

FIG. 2A is a block diagram showing a device group management system according to an example. As shown in FIG. 2A, the device group management system includes a management terminal 210, a target device 220 and reference devices 230.

The management terminal 210 is configured to, after receiving an adding instruction for adding the target device 220 into a target group, send a broadcasting instruction to the target device 220.

The target device 220 is a smart device selected using the management terminal 210 by a user for the purpose of grouping.

The target group referred to herein may be a group established by the user for containing multiple smart devices. To facilitate collective management, the target group may be used to contain smart devices that may be located in the same room or that need to be controlled simultaneously.

The target group may be preset by the management terminal 210, or may be added manually by the user. When the target group is added manually by the user, the user may name the added target group.

For example, if the target group is named “Living Room”, all the smart devices in the living room such as smart electric lamps and smart TVs may be contained in the “Living Room” group. Then, the user can control all the smart devices in the living room simultaneously by using the management terminal 210.

The adding instruction may be an instruction generated when the user selects and adds a smart device into the target group. For example, if a user selects a smart device listed in the management terminal 210 and triggers an adding widget provided for a target group, the management terminal 210 generates an instruction of adding the smart device into the target group.

The management terminal 210 receives the instruction of adding the smart device 220 into the target group after it is generated. After receiving the instruction, the management terminal 210 sends a broadcasting instruction to the target device 220. The broadcasting instruction is used to instruct the target device 220 to broadcast a signal.

In a possible implementation, when sending the broadcasting instruction to the target device 220, the management terminal 210 may further specify the number of times for the target device 220 to broadcast the signal and the time interval for broadcasting the signal. For example, the management terminal 210 may add a designated number of times and a designated time interval as parameters into a data packet corresponding to the broadcasting instruction. Accordingly, when receiving the data packet, the target device 220 may derive the designated number of times and the designated time interval carried therein, and broadcast a signal every the time interval designated by the management terminal 210 until the signal is broadcast the designated number of times. By this way, the chance is increased for each reference device 230 to receive the signal broadcasted by the target device 220.

Optionally, the broadcasting instruction may not specify the number of times and the time interval for the target device 220 to broadcast the signal. The target device 220 may broadcast the signal according to a preset number of times and a preset time interval. The preset number of times and the preset time interval may be saved in the management terminal 210.

Optionally, the management terminal 210 sends the broadcasting instruction to the target device 220. The broadcasting instruction may include a power value by which the target device 220 broadcasts a signal. Accordingly, the target device 220 may broadcast the signal according to the power value carried by the broadcasting instruction.

Optionally, the broadcasting instruction may not carry a power value. The target device 220 may broadcast a signal according to a preset power value that is saved in the management terminal.

The target device 220 is configured to, after receiving the broadcasting instruction sent by the management terminal 210, broadcast a signal.

After receiving the broadcasting instruction sent by the management terminal 210, the target device 220 broadcasts a signal. The target device 220 may broadcast the signal according to a preset power value or a power value carried in the broadcasting instruction and designated by the management terminal 210.

In practical implementation, reference devices 230 are often located near the target device 220, so the reference devices 230 can receive the signal broadcasted by the target device 220. Further, each of the reference devices 230 is configured to, after receiving the signal, acquire signal strength of the received signal and feed the signal strength back to the management terminal 210.

In a possible implementation, in addition to the signal strengths of their received signals, the reference devices 230 may feed their own identifications back to the management terminal 210.

Optionally, when feeding the signal strength back to the management terminal 210, each reference device 230 may encapsulate the signal strength in the payload of a data packet. Optionally, the reference device 230 may encapsulate its own identification in the payload or header of a data packet, so that the management terminal 210 can acquire the signal strength of the signal received by the reference device 230 and the identification of the reference device 230 after decapsulating the data packet.

The management terminal 210 is further configured to sort the reference devices 230 based on the signal strengths fed back by the reference devices 230.

In a possible implementation, the management terminal 210 may sort the reference devices 230 in a descending order of the signal strengths fed back by the reference devices 230. Generally, when feeding back the signal strengths, the reference devices 230 will feed back their own identifications. Thus, the management terminal 210 may sort the identifications corresponding to the signal strengths received from the reference devices 230.

To perform grouping of smart devices, the management terminal 210 first needs to automatically acquire the identifications of the smart devices, and then provides the smart devices to the user for selecting one of them as a target device. Optionally, the smart devices acquired by the management terminal 210 are associated with a user account for logging in the management terminal 210 or are located in a local area network (LAN) of the management terminal 210.

In practical implementation, the management terminal 210 is further configured to: receive a setting instruction for setting the target group, and based on the setting instruction, generate the target group for which a widget for adding target devices 220 is provided and may be displayed in the management terminal, after the widget is triggered, display acquired smart devices; and selecting a smart device as the target device 220 by a user.

For example, refer to FIG. 2B which shows three interfaces 20, 21 and 22 of the management terminal 210 displayed at different times. A “Living Room Group” 23 is shown in the interface 20. A widget 24 for adding a target device 220 is provided below the “Living Room Group” 23. When the user clicks the widget 24, the management terminal 210 displays the interface 21 in which a list of multiple smart devices is displayed. The multiple smart devices in the list may be associated with the user account for logging in the management terminal 210 or are located in the same LAN as the management terminal 210. When the control corresponding to the smart electric lamp 26 in the interface 21 is triggered, the management terminal 210 determines the smart electric lamp 26 as the target device 220.

That is, the management terminal 210 receives an adding instruction for adding the target device 220 into the “Living Room Group” 23. At this time, smart devices other than the smart electric lamp 26 are reference devices 230. Then, the management terminal 210 sends a broadcasting instruction to the smart electric lamp 26 (namely the target device 220). The smart electric lamp 26 broadcasts a signal based on the broadcasting instruction. The reference devices 230 receive the broadcasted signal and feed the signal strengths of their received signals to the management terminal 210. As shown in FIG. 2B, the management terminal 210 displays the interface 22 for the user, based on the signal strengths fed back by the reference devices 230. The interface 22 includes a list box 28 for displaying sorted reference devices 230 to the user.

It should be noted that the widget and the characters in FIG. 2B are only illustrative examples, and are not intended to restrict the presentation of the actual products of the present disclosure. The parts not completely shown are blocked by corresponding floating boxes. In principle, when a floating box is displayed, the parts not completely shown cannot be directly operated or viewed by the user.

In a possible implementation, the types of the smart devices in the same group may be the same. In this case, when adding a target device, the smart devices having the same type as the target device can be displayed, so that the user can subsequently select and add a smart device into the group. Then, the management terminal 210 is further configured to acquire a type of the target device 220 and select the reference devices 230 having the type of the target device 220 or select the reference devices 230 having signal strengths that are higher than a predetermined strength threshold, and sort the selected reference devices 230 based on the signal strengths fed back by the reference devices 230.

For example, if the type of the target device 220 acquired by the management terminal 210 is “Smart Electric Lamp”, only sorted smart electric lamps can be displayed in the list box 28 for displaying the sorted smart devices. Alternatively, after receiving the signal strengths fed back by the reference devices 230, the management terminal 210 selects the reference devices 230 having signal strengths that are higher than the predetermined strength threshold. Then, only the reference devices 230 having signal strengths that are higher than the predetermined strength threshold may be displayed in the list box 28. By doing so, the user can manage and maintain the smart devices of the same type in the same room more conveniently, the time for sorting reference devices can be reduced and the sorting efficiency can be improved.

Sometimes, a number of pre-determined groups may be setup by the system. For example, two or more groups of devices that could serve one room or one area of the house may be pre-determined. Each group may include one or more devices. The user interface may display the two or more groups for the user to select one group to serve the room or the one area of the house.

Optionally, the management terminal 210 is further configured to select one of the sorted reference devices 230 and add the selected reference device into the target group.

In FIG. 2B, if the user clicks “TV” in the list box 28 and clicks the confirm control 29, then all smart devices of TVs are added into the “Living Room Group” 23.

In practical implementation, the signal broadcast by the target device 220 may be lost or may be interfered. To prevent such condition from affecting reception of the signal by the reference devices 230, the target device 220 may broadcast the signal multiple times. In order for the signal received by a reference device 230 to reflect the distance from the reference device 230 to the target device 220, the target device 220 is further configured to broadcast the signal according to the same transmission power, for example, broadcast the signal with the same transmission power.

To sum up, in the device group management system provided by the present disclosure, the management terminal sends a broadcasting instruction to the target device when pre-grouping is performed by the management terminal. After receiving a signal broadcasted by the target device, each of the reference devices obtains and feeds signal strength of the received signal broadcasted by the target device back to the management terminal, in which the reference devices are sorted based on the signal strengths. This solves the problem that it is not efficient for the grouping process to find smart devices one by one and reduce the error rate of finding the smart devices. The disclosed system is convenient for users to quickly select devices that may be in the same group as the target device and thus the grouping efficiency and accuracy are improved.

After a user clicks the widget for adding the target device, selectable target devices are displayed for the user, so that the time for finding devices one by one is saved.

By acquiring a type of the target device and selecting the reference devices having the same type as the target device or selecting the reference devices having signal strengths that are higher than a predetermined strength threshold, and sorting the selected reference devices based on the signal strengths fed back by the reference devices, a user can manage and maintain the smart devices in the same room more conveniently, the time for sorting reference devices can be reduced and the sorting efficiency can be improved.

By adding a reference device selected by a user from the sorted reference devices into the target group, the reference device can be added into the target group very quickly.

As the target device broadcasts the signal according to the same transmission power, the signal strengths of signals received by the reference devices can effectively reflect the distances between the respective reference devices and the target device. Accordingly, the management terminal can list the reference devices according to their distances to the target device by sorting based on the signal strengths fed back by the reference devices, thereby improving the effectiveness and accuracy of sorting the reference devices.

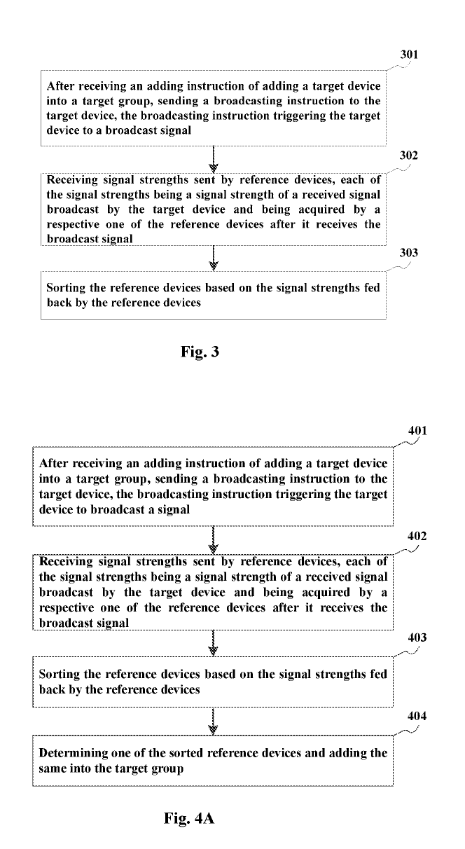

FIG. 3 is a flow chart showing a device group management method according to an example. The smart device group management method may be applied in the management terminal 120 in the application environment shown in FIG. 1. As shown in FIG. 3, the smart device group management method may include the following steps.

In Step 301, after receiving an adding instruction of adding a target device into a target group, a broadcasting instruction is sent to the target device where the broadcasting instruction triggers the target device to broadcast a signal.

In Step 302, signal strengths sent by reference devices are received, where each of the signal strengths is signal strength of a received signal broadcasted by the target device and is acquired by one of the reference devices after it receives the broadcast signal.

In Step 303, the reference devices are sorted based on the signal strengths fed back by and received from the reference devices.

To sum up, with the device group management method provided by the present disclosure, the management terminal sends a broadcasting instruction to the target device when pre-grouping is performed by the management terminal. After receiving a signal broadcasted by the target device, each of the reference devices feeds signal strength of its received signal broadcasted by the target device back to the management terminal, in which the reference devices are sorted based on the signal strengths. This solves the problem that the grouping process involving finding smart devices one by one is of low efficiency and has high error rate. This method provides a way that it is convenient for users to quickly select devices that may be in the same group as the target device, and thus, the grouping efficiency and accuracy for smart devices are improved.

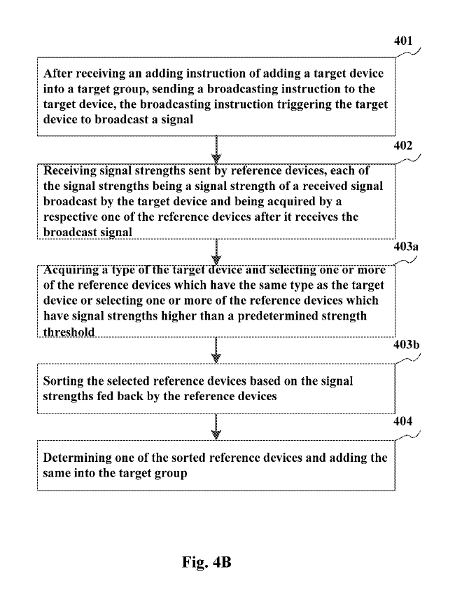

FIG. 4A is a flow chart showing a device group management method according to another example. The smart device grouping method may be applied in the management terminal 120 in the application environment shown in FIG. 1. As shown in FIG. 4A, the smart device grouping method may include the following steps.

In Step 401, after receiving an adding instruction of adding a target device into a target group, a broadcasting instruction is sent to the target device, and the broadcasting instruction triggers the target device to broadcast a signal.

The target device is a smart device selected using the management terminal by a user for the purpose of grouping.

The target group discussed herein may be a group established by the user for containing multiple smart devices. For example, to facilitate collective management, the target group may be used to contain smart devices that may be located in the same room or may be needed to be controlled simultaneously.

The target group may be preset by the management terminal, or may be added manually by the user. When the target group is added manually by the user, the user may name the added target group.

The adding instruction may be an instruction generated when the user adds a selected smart device into the target group. For example, if a user selects a smart device listed in the management terminal and triggers an adding widget displayed in the management terminal that is provided for a target group, the management terminal generates an instruction for adding the smart device into the target group.

In a possible implementation, when sending the broadcasting instruction to the target device, the management terminal may further specify the number of times for the target device to broadcast the signal and the time interval for broadcasting the signal. For example, the management terminal may add a designated number of times and a designated time interval as parameters into a data packet corresponding to the broadcasting instruction. Accordingly, when receiving the data packet, the target device may derive the designated number of times and the designated time interval carried therein, and broadcast a signal every the time interval designated by the management terminal until the signal is broadcast the designated number of times. In this way, it can increase the chance for each reference device to receive the signal broadcasted by the target device.

Optionally, the broadcasting instruction may not specify the number of times for the target device 220 to broadcast the signal and may not specify the time interval for broadcasting the signal. The target device may broadcast the signal according to a preset number of times and a preset time interval for broadcasting the signal. The preset number of times and the preset time interval for broadcasting the signal may be stored in the management terminal.

Optionally, the management terminal sends the broadcasting instruction to the target device. The broadcasting instruction may include a power value by which the target device broadcasts a signal. Accordingly, the target device may broadcast the signal according to the power value carried by the broadcasting instruction.

Optionally, the broadcasting instruction may not carry a power value. The target device may broadcast a signal according to a preset power value that may be saved in the management terminal.

In Step 402, signal strengths sent by reference devices are received, and each of the signal strengths is signal strength of a received signal broadcasted by the target device and is acquired by one of the reference devices after it receives the broadcasted signal.

The management terminal receives signal strengths sent by reference devices, each of the signal strengths is signal strength of a received signal broadcasted by the target device and is acquired by one of the reference devices after it receives the signal.

Optionally, in addition to the signal strengths of their received signals, the reference devices may feed their own identifications back to the management terminal.

Optionally, when feeding the signal strength back to the management terminal, each reference device may encapsulate the signal strength in the payload of a data packet. Optionally, the reference device may encapsulate its own identification in the payload or header of a data packet, so that the management terminal can acquire the signal strength of the signal received by the reference device and the identification of the reference device after decapsulating the data packet.

In Step 403, the reference devices are sorted based on the signal strengths fed back by and/or received from the reference devices.

In a possible implementation, the management terminal may sort the reference devices in a descending order of the signal strengths fed back by the reference devices. When feeding back the signal strengths, the reference devices may feed back their own identifications. Thus, the management terminal may sort the identifications corresponding to the signal strengths.

In another possible implementation, a reference may be established for relevant devices. For example, a reference may be established for a printer and a computer. The management terminal may display the devices according to the reference established. For example, a computer may be displayed to be together with a printer. As such, the user may be able to select related devices together.

To perform grouping of smart devices, the management terminal first needs to automatically acquire the identifications of the smart devices, and then provides the smart devices to the user for selecting one of them as a target device. Optionally, the smart devices acquired by the management terminal are associated with a user account for logging in the management terminal or are located in the same LAN as the management terminal.

In Step 404, one of the sorted reference devices is selected and is added into the target group.

After receiving a reference device that is selected by the user from the sorted reference devices, the management terminal adds the reference device selected by the user into the target group. In this way, the target device and the reference device selected by the user are arranged in the same target group.

To sum up, in the device group management method provided by the present disclosure, the management terminal sends a broadcasting instruction to the target device when pre-grouping is performed by the management terminal. After receiving a signal broadcasted by the target device, each of the reference devices feeds signal strength of its received signal broadcasted by the target device back to the management terminal, in which the reference devices are sorted based on the signal strengths. This solves the problem that the grouping process involving finding smart devices one by one is of low efficiency and has high error rate. This method provides a way that it is convenient for users to quickly select devices that may be in the same group as the target device and this method improves the grouping efficiency and accuracy.

When the target device broadcasts signals according to the same transmission power, the signal strengths of signals received by the reference devices can reflect the distances between the respective reference devices and the target device. Accordingly, the management terminal can perform sorting based on the signal strengths fed back by the reference devices to reflect the distances between the respective reference devices and the target device. As such, the accuracy of sorting the reference devices is improved.

It should be noted that, in practical implementation, the types of the smart devices in the same group may be the same. In this case, when adding a target device, the smart devices having the same type as the target device can be displayed, so that the user can subsequently select and add a smart device into the group. In this case, referring to FIG. 4B, step 403 may be replaced with steps 403a and 403b.

In Step 403a, a type of the target device is acquired and the reference devices having the same type as the target device are selected or the reference devices having signal strengths that are higher than a predetermined strength threshold are selected.

In Step 403b, the selected reference devices are sorted based on the signal strengths fed back by the reference devices.

The above steps have been described in the above system example, and will not be repeated in this example.

By acquiring a type of the target device and selecting the reference devices having the same type as the target device or selecting the reference devices having signal strengths that are higher than a predetermined strength threshold, and sorting the selected reference devices based on the signal strengths fed back by the reference devices, a user can manage and maintain the smart devices in the same room conveniently, the time for sorting reference devices can be reduced and the sorting efficiency can be improved.

It should be further noted that, referring to FIG. 4C, before step 401, the method may further include steps 400a, 400b and 400c.

In Step 400a, a setting instruction for setting the target group is received and the target group is generated based on the setting instruction. For the target group, a widget for adding the target device is provided and may be displayed in a management terminal.

In Step 400b, after the widget is triggered, acquired smart devices may be displayed in the management terminal, and the acquired smart devices may be associated with a user account for logging in the management terminal or are located in a local area network (LAN) of the management terminal.

In Step 400c, a selected smart device among the displayed smart devices is selected and determined as the target device.

After the user clicks the widget that may be displayed in the management terminal for adding the target device, selectable target devices may be displayed for the user to pick and choose. Thus, the time for finding devices one by one is saved.

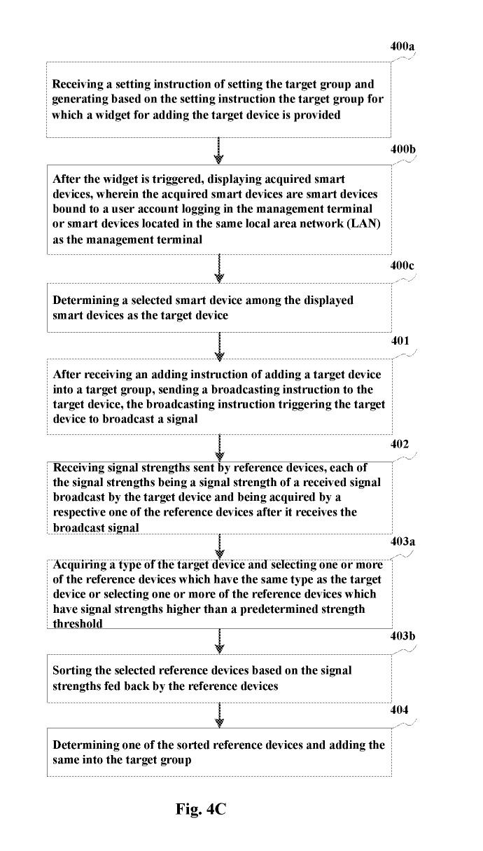

FIG. 5 is a block diagram showing a device group management apparatus according to an example. The device group management apparatus may be structured as the management terminal 120 in the above application environment or a part of it in the form of software, hardware or a combination thereof. As shown in FIG. 5, the device group management apparatus may include a sending module 510, signal strength receiving module 520 and a sorting module 530.

The sending module 510 is configured to, after an adding instruction of adding a target device into a target group is received, send a broadcasting instruction to the target device, and the broadcasting instruction triggers the target device to broadcast a signal.

The target device is a smart device selected at the management terminal by a user for the purpose of grouping.

The target group discussed herein may be a group established by the user for containing multiple smart devices. The target group may be used to contain smart devices that may be located in the same room or may be controlled simultaneously to facilitate collective management. In practical implementation, the target group may be preset by the management terminal, or may be added manually by the user. When the target group is added manually by the user, the user may name the added target group.

The adding instruction may be an instruction generated when the user adds a selected smart device into the target group. For example, if a user selects a smart device listed in the management terminal and triggers an adding widget displayed in the terminal that is provided for a target group, the management terminal generates an instruction for adding the smart device into the target group.

Optionally, when sending the broadcasting instruction to the target device, the sending module 510 may further specify the number of times for the target device to broadcast the signal and may specify the time interval for broadcasting the signal. For example, the sending module 510 may add a designated number of times and a designated time interval as parameters into a data packet corresponding to the broadcasting instruction. Accordingly, when receiving the data packet, the target device may derive the designated number of times and the designated time interval carried therein, and broadcast a signal every the time interval designated by the sending module 510 until the signal is broadcast the designated number of times. In this way, it can increase the chance for each reference device to receive the signal broadcasted by the target device.

Optionally, the broadcasting instruction may not specify the number of times for the target device to broadcast the signal and may not specify the time interval for broadcasting the signal either. The target device may broadcast the signal according to a preset number of times and a preset time interval for broadcasting the signal. The preset number of times and the preset time interval for broadcasting the signal may be stored in the management terminal.

Optionally, the sending module 510 sends the broadcasting instruction to the target device. The broadcasting instruction may include a power value by which the target device broadcasts the signal. Accordingly, the target device may broadcast the signal according to the power value carried by the broadcasting instruction.

Optionally, the broadcasting instruction may not carry a power value. The target device may broadcast a signal according to a preset power value that may be stored in the management terminal.

The signal strength receiving module 520 is configured to receive signal strengths sent by reference devices, and each of the signal strengths is signal strength of a received signal broadcasted by the target device and is acquired by one of the reference signals after it receives the broadcast signal.

Optionally, in addition to the signal strengths of their received signals, the reference devices may feed their own identifications back to the signal strength receiving module 520.

Optionally, when feeding the signal strength back to the signal strength receiving module 520, each reference device may encapsulate the signal strength in the payload of a data packet. Optionally, the reference device may encapsulate its own identification in the payload or header of a data packet, so that the signal strength receiving module 520 can acquire the signal strength of the signal received by the reference device and the identification of the reference device after de-encapsulating the data packet.

The sorting module 530 is configured to sort the reference devices based on the signal strengths fed back by the reference devices and received by the signal strength receiving module 520.

Optionally, the sorting module 530 is configured to sort the reference devices in a descending order of the signal strengths fed back by the reference devices and received by the signal strength receiving module 520.

Generally, when feeding back the signal strengths, the reference devices will feed back their own identifications. Thus, the sorting module 530 may sort the identifications corresponding to the signal strengths.

To perform grouping of smart devices, the management terminal first needs to automatically acquire the identifications of the smart devices, and then provides the smart devices to the user for selecting one of them as a target device. Optionally, the smart devices acquired by the management terminal are associated with a user account for logging in the management terminal or are located in the same LAN as the management terminal.

Optionally, the types of the smart devices in the same group may be the same. In this case, when adding a target device, the smart devices having the same type as the target device can be displayed. The user can then subsequently select and add a smart device into the group. Then, the sorting module 530 may further include an acquiring sub-module 531 and a sorting sub-module 532.

The acquiring sub-module 531 is configured to acquire a type of the target device and select the reference devices having the same type as the target device or select the reference devices having signal strengths that are higher than a predetermined strength threshold.

The sorting sub-module 532 is configured to sort the selected reference devices based on the signal strengths fed back by the reference devices that are acquired by the acquiring sub-module 531.

By acquiring a type of the target device and selecting the reference devices having the same type as the target device or selecting the reference devices having signal strengths that are higher than a predetermined strength threshold using the acquiring sub-module 531, and sorting the selected reference devices based on the signal strengths fed back by the reference devices using the sorting sub-module 532, a user can manage and maintain the smart devices in the same room conveniently, the time for sorting reference devices can be reduced and the sorting efficiency can be improved.

Optionally, the apparatus further may include a generating module 540, a displaying module 550 and a determining module 560.

The generating module 540 is configured to receive a setting instruction for setting the target group and generate, based on the setting instruction, the target group for which a widget for adding the target device is provided and is displayed in a management terminal.

The displaying module 550 is configured to, after the widget generated by the generating module 540 is triggered, display acquired smart devices, where the acquired smart devices are associated with a user account for logging in the management terminal or are located in a local area network (LAN) of the management terminal.

The determining module 560 is configured to determine a smart device among the smart devices displayed by the displaying module 550 as the target device.

Optionally, the apparatus may further include an adding module 570.

The adding module 570 is configured to select one of the reference devices sorted by the sorting module 530 and add the selected reference device into the target group.

To sum up, using the device group management apparatus provided by the present disclosure, the management terminal sends a broadcasting instruction to the target device when pre-grouping is performed by the management terminal. After receiving a signal broadcasted by the target device, each of the reference devices feeds signal strength of its received signal broadcasted by the target device back to the management terminal, in which the reference devices are sorted based on the signal strengths. This solves the problem that the grouping process involving finding smart devices one by one is of low efficiency and may have high error rate. This apparatus provides a way that it is convenient for users to quickly select devices that may be in the same group as the target device and the grouping efficiency and accuracy are thus improved.

After a user clicks the widget displayed in the management terminal for adding the target device, selectable target devices are displayed for the user to select, and thus, the time for finding and searching devices one by one is saved.

By acquiring a type of the target device and selecting the reference devices having the same type as the target device or selecting the reference devices having signal strengths that are higher than a predetermined strength threshold, and sorting the selected reference devices based on the signal strengths fed back by the reference devices, a user can manage and maintain the smart devices in the same room conveniently, the time for sorting reference devices can be reduced and the sorting efficiency can be improved.

By adding a reference device selected by a user from the sorted reference devices into the target group, the reference device can be added into the target group very quickly.

When the target device broadcasts the signal according to the same transmission power, the signal strengths of signals received by the reference devices can reflect the distances between the respective reference devices and the target device. Accordingly, the management terminal can perform sorting based on the signal strengths fed back by the reference devices to reflect distances between the respective reference devices and the target device. The effectiveness and accuracy of sorting the reference devices are improved.

With respect to the apparatuses in the above examples, the specific manners for performing operations for individual modules therein have been described in detail in the examples regarding the related methods, and will not be elaborated herein.

An example of the present disclosure provides a device group management apparatus, which can implement the device group management method provided by the examples of the present disclosure and which may include a processor and a memory storing instructions executable by the processor. The processor is configured to: after receiving an adding instruction for adding a target device into a target group, send a broadcasting instruction to the target device where the broadcasting instruction triggers the target device to broadcast a signal, receive signal strengths sent by reference devices where each of the signal strengths is signal strength of a received signal broadcasted by the target device and is acquired by one of the reference devices after it receives the signal, and sort the reference devices based on the signal strengths fed back by the reference devices.

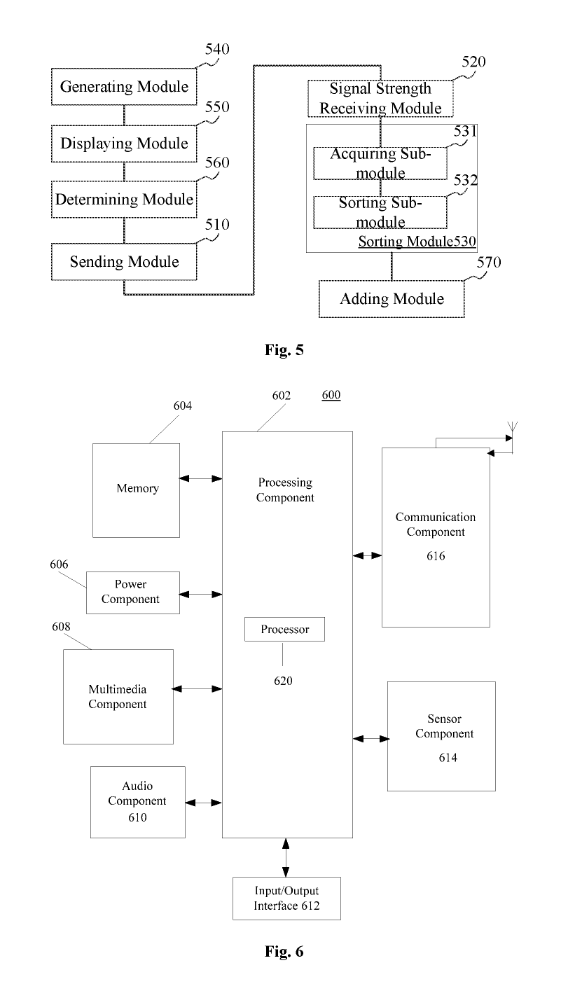

FIG. 6 is a block diagram showing a device group management apparatus according to another example. For example, the apparatus 600 may be a mobile phone, a computer, a digital broadcast terminal, a messaging device, a gaming console, a tablet, a medical device, exercise equipment, a personal digital assistant or the like.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the apparatus 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604, other than transitory, is configured to store various types of data to support the operation of the apparatus 600. Examples of such data include instructions for any applications or methods operated on the apparatus 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the apparatus 600. The power component 606 may include a power management system, one or more power sources, and any other components associated with the generation, management, and distribution of power in the apparatus 600.

The multimedia component 608 includes a screen providing an output interface between the apparatus 600 and the user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some examples, the multimedia component 608 includes a front camera and/or a rear camera. The front camera and the rear camera may receive an external multimedia datum while the apparatus 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the apparatus 600 is in an operation mode, such as a call mode, a recording mode, and a voice recognition mode. The received audio signal may be further stored in the memory 604 or transmitted via the communication component 616. In some examples, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the apparatus 600. For instance, the sensor component 614 may detect an open/closed status of the apparatus 600, relative positioning of components, e.g., the display and the keypad, of the apparatus 600, a change in position of the apparatus 600 or a component of the apparatus 600, a presence or absence of user contact with the apparatus 600, an orientation or an acceleration/deceleration of the apparatus 600, and a change in temperature of the apparatus 600. The sensor component 614 may include a proximity sensor configured to detect the presence of nearby objects without any physical contact. The sensor component 614 may also include a light sensor, such as a CMOS or CCD image sensor, for use in imaging applications. In some examples, the sensor component 614 may also include an accelerometer sensor, a gyroscope sensor, a magnetic sensor, a pressure sensor, or a temperature sensor.

The communication component 616 is configured to facilitate communication, wired or wirelessly, between the apparatus 600 and other devices. The apparatus 600 can access a wireless network based on a communication standard, such as WiFi, 2G; or 3G or a combination thereof. In one exemplary example, the communication component 616 receives a broadcast signal or broadcast associated information from an external broadcast management system via a broadcast channel. In one exemplary example, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary examples, the apparatus 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary examples, there is also provided a non-transitory computer-readable storage medium including instructions, such as included in the memory 604, executable by the processor 620 in the apparatus 600, for performing the above-described methods. For example, the non-transitory computer-readable storage medium may be a ROM, a RAM, a CD-ROM, a magnetic tape, a floppy disc, an optical data storage device, and the like.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Other examples of the disclosure will be apparent to those skilled in the art from consideration of the specification and practice disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof.

1. A device group management system, comprising a management terminal, a target device and reference devices, wherein
the management terminal is configured to, after receiving an adding instruction for adding the target device into a target group, send a broadcasting instruction to the target device;
the target device is configured to, after receiving the broadcasting instruction, broadcast a signal;
at least one of the reference devices is configured to, after receiving the signal, acquire signal strength of the received signal and feed the signal strength back to the management terminal; and
the management terminal is further configured to sort the reference devices based on the signal strength of the at least one reference device fed back by the reference devices.

2. The system of claim 1, wherein the management terminal is further configured to:
receive a setting instruction for setting the target group;
based on the setting instruction, generate the target group for which a widget for adding the target device is provided;
after the widget is triggered, display acquired smart devices; and
determine a smart device selected from the acquired smart devices by a user as the target device, wherein the acquired smart devices are associated with a user account for logging in the management terminal or are located in a local area network (LAN) of the management terminal.

3. The system of claim 1, wherein the management terminal is further configured to:
acquire a type of the target device,
select one or more of the reference devices which have the type of the target device or select one or more of the reference devices which have signal strengths that are higher than a predetermined strength threshold, and
sort the selected reference devices, based on the signal strengths fed back by the reference devices.

4. The system of claim 1, wherein the management terminal is further configured to select one of the sorted reference devices and add the selected reference device into the target group.

5. The system of claim 1, wherein the target device is further configured to broadcast the signal having same transmission power.

6. A device group management method, comprising:
after receiving an adding instruction for adding a target device into a target group, sending a broadcasting instruction to the target device, wherein the broadcasting instruction triggers the target device to broadcast a signal;
receiving signal strengths sent by reference devices, wherein at least one of the signal strengths is signal strength of a received signal broadcasted by the target device and is acquired by one of the reference devices after it receives the broadcasted signal; and
sorting the reference devices based on the signal strengths fed back by the reference devices.

7. The method of claim 6, wherein sorting the reference devices based on the signal strengths fed back by the reference devices comprises:
acquiring a type of the target device,
selecting one or more of the reference devices which have the type of the target device or selecting one or more of the reference devices which have signal strengths that are higher than a predetermined strength threshold, and
sorting the selected reference devices based on the signal strengths fed back by the reference devices.

8. The method of claim 6, further comprising:
receiving a setting instruction for setting the target group;
based on the setting instruction, generating the target group for which a widget for adding the target device is provided;
after the widget is triggered, displaying acquired smart devices, wherein the acquired smart devices are associated with a user account for logging in the management terminal or are located in a local area network (LAN) of the management terminal; and
selecting a smart device from the displayed smart devices as the target device.

9. The method of claim 6, further comprising selecting one of the sorted reference devices and adding the selected reference device into the target group.

10. The method of claim 6, wherein sorting the reference devices based on the signal strengths fed back by the reference devices comprises sorting the reference devices in a descending order of the signal strengths fed back by the reference devices.

11. A device group management apparatus, comprising:
a processor; and
a memory storing instructions executable by the processor,
wherein the processor is configured to:
after receiving an adding instruction of adding a target device into a target group, send a broadcasting instruction to the target device, wherein the broadcasting instruction triggers the target device to broadcast a signal; and
receive signal strengths sent by reference devices, wherein at least one of the signal strengths is signal strength of a received signal broadcasted by the target device and is acquired by one of the reference devices after it receives the signal; and
sort the reference devices based on the signal strengths fed back by the reference devices.

12. The apparatus of claim 11, wherein the processor is further configured to:
acquire a type of the target device,
select one or more of the reference devices which have the type of the target device or select one or more of the reference devices which have signal strengths that are higher than a predetermined strength threshold, and
sort the selected reference devices based on the signal strengths fed back by the reference devices.

13. The apparatus of claim 11, wherein the processor is further configured to:
receive a setting instruction for setting the target group;
based on the setting instruction, generate the target group for which a widget for adding the target device is provided;
after the widget is triggered, display acquired smart devices, wherein the acquired smart devices are associated with a user account logging in the management terminal or are located in a local area network (LAN) of the management terminal; and
select a smart device among the displayed smart devices as the target device.

14. The apparatus of claim 11, wherein the processor is further configured to select one of the sorted reference devices and adding the selected reference device into the target group.

15. The apparatus of claim 11, wherein the processor is further configured to sort the reference devices in a descending order of the signal strengths fed back by the reference devices.

16. The apparatus of claim 12, wherein the processor is further configured to sort the reference devices in a descending order of the signal strengths fed back by the reference devices.

17. The apparatus of claim 13, wherein the processor is further configured to sort the reference devices in a descending order of the signal strengths fed back by the reference devices.

18. The apparatus of claim 14, wherein the processor is further configured to sort the reference devices in a descending order of the signal strengths fed back by the reference devices.
